(19) United States
(12) Patent Application Publication
(10) Pub. No.: US 2020/0327356 A1
(43) Pub. Date: Oct. 15, 2020

(54) GENERATION OF DIGITAL DOCUMENT FROM ANALOG DOCUMENT

(71) Applicant: CAMDEN TOWN TECHNOLOGIES PRIVATE LIMITED, Bengaluru (IN)

(72) Inventors: Mikhil Raj, Bangalore (IN); Karan Varshney, Aligarh (IN)

(73) Assignee: CAMDEN TOWN TECHNOLOGIES PRIVATE LIMITED, Bengaluru (IN)

(21) Appl. No.: 16/453,615

(22) Filed: Jun. 26, 2019

(30) Foreign Application Priority Data
Apr. 10, 2019 (IN) 201941014565

(51) Int. Cl. G06K 9/62; G06K 9/32

(52) U.S. Cl. CPC G06K 9/6203; G06K 9/3233

(57) ABSTRACT

Generation of a digital document from an analog document is provided. The document generation includes obtaining a user image of a user-filled document. A first set of key points and a second set of key points are extracted from a template image and the user image, respectively. Probabilistic matching of the first set of key points and the second set of key points is performed to determine a transformation. An inverse transformation is performed on the transformation to transform back one or more areas of interest into an image-space of the template image. A mask is generated for the one or more areas of interest in the user image. The mask is further merged onto a corresponding area of the template image to generate the digital document.

### CROSS-RELATED APPLICATIONS

This application claims priority of Indian Application Serial No. 201941014565, filed Apr. 10, 2019, the contents of which are incorporated herein by reference.

### FIELD

Various embodiments of the disclosure relate generally to image processing. More specifically, various embodiments of the disclosure relate to generation of a digital document from an analog document.

### BACKGROUND

Data collection remains a persistent problem in the pursuit of data quality. Very often, the input of information by individual respondents is achieved through the use of a form. Printed forms have been in use for many years, but remain notoriously error-prone and confusing. The introduction of online, web-based data collection instruments has not led to improvements in form design. Instead, the limitations of print forms have been faithfully reproduced, despite the possibilities of programmatic assistance.

Generally, a form is used to collect similar information from multiple users. The structure of the form helps in keeping the information in a structured format. The structural format of the form helps the users to provide information in predefined spaces. In today's world, proliferation in the use of computers, electronic documents, internet, and use of electronic forms can help the users to provide their information conveniently.

However, many organizations prefer to collect employee data by distributing a hardcopy of the same form among the employees. Large organizations have hundreds and thousands of employees. So, it is difficult for the organizations to keep a track of the hardcopy of each hand-filled form of each employee. Also, hundreds and thousands of hardcopies of the hand-filled form requires a large physical storage space that may not be desirable for any organization. Thus, it is important for the organizations to keep a softcopy of each form that was previously hand-filled by each employee. In one solution, a person may be designated for creating the softcopy of each hand-filled form. However, it is time consuming and hectic task for the person for keeping the data of each employee up to date or creating the softcopy of each form. The person may miss out on some key content while creating the softcopy of the form. Other solution is to scan or take an image of the hand-filled form and store the scanned copy or the image copy of each employee in a memory. However, not all content filled by each employee is important. Different organizations may have different preferences for the content to be filled by the employees. Storing the entire scanned copy or the entire image copy may result in using unnecessary memory space that is also not desirable to most of the organizations.

In light of the foregoing, there exists a need for a technical and reliable solution that overcomes the above-mentioned problems, challenges, and short-comings, and manages generation of a digital document from an analog document (i.e., a hand-filled form) such that the digital document includes key content as hand-filled by a user.

### SUMMARY

Generation of a digital document from an analog document is provided substantially as shown in, and described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an environment for document generation, in accordance with an exemplary embodiment of the disclosure;

FIG. 2 is a block diagram that illustrates a computing server of the environment of FIG. 1, in accordance with an exemplary embodiment of the disclosure;

FIG. 3 is a diagram that illustrates a template image of a first template document, in accordance with an exemplary embodiment of the disclosure;

FIG. 4 is a diagram that illustrates a user image of a second template document hand-filled by a user, in accordance with an exemplary embodiment of the disclosure;

FIG. 5A is a diagram that illustrates an exemplary scenario for document generation, in accordance with an exemplary embodiment of the disclosure;

FIG. 5B is a diagram that illustrates an exemplary scenario for document generation, in accordance with another exemplary embodiment of the disclosure;

FIGS. 6A-6B, collectively, illustrate a flow chart of a method for generating a digital document, in accordance with an exemplary embodiment of the disclosure; and

FIG. 7 is a block diagram that illustrates a system architecture of a computer system for generating the digital document, in accordance with an exemplary embodiment of the disclosure.

### DETAILED DESCRIPTION

Certain embodiments of the disclosure may be found in a disclosed apparatus for document generation. Exemplary aspect of the disclosure provides a method and a system for generating a digital document from an analog document (such as a form hand-filled by a user). The method includes one or more operations that are executed by a computing server to generate the digital document from the analog document. The computing server may be configured to receive, from a user-computing device of the user via a communication network, a user image of a user-filled document. The user image may be generated based on capturing of the user-filled document by the user-computing device. The user-filled document may be an updated copy of a template image that has been updated by the user by incorporating analog content in one or more areas of the template image. The analog content may be handwritten content filled-in by the user.

The computing server may be further configured to extract a first set of key points from a template image, and a second set of key points from the user image. The computing server may be further configured to determine a transformation that maps each pixel coordinate of the template image to a pixel coordinate of the user image. The transformation may be determined based on a matching between the first set of key points and the second set of key points such that the matching is greater than a threshold value. The transformation may be indicative of one or more locations of one or more areas of interest in the user image. The matching of the first set of key points and the second set of key points may be executed based on a first set of descriptors and a second set of descriptors to obtain one-to-one mapping between a first subset of the first set of key points and a second subset of the second set of key points. The first set of descriptors of the first set of key points and the second set of descriptors of the second set of key points may be extracted from the template image and the user image, respectively. The computing server may be further configured to execute an inverse transformation of the determined transformation based on the one or more areas of interest. The inverse transformation may be executed by transforming back the one or more areas of interest into an image-space of the template image. The inverse transformation may include at least correcting orientation, rotation, and perspective of the one or more areas of interest.

The computing server may be further configured to mask each area of interest to obtain a mask including at least foreground information of each area of interest. In one embodiment, the mask of an area of interest may include specific portions of the area of interest, and the specific portions may include at least the foreground information. A combined shape and size of the specific portions may be less than an actual shape and size of the area of interest. The computing server may be further configured to generate one or more contours based on at least the foreground information of the area of interest to obtain the specific portions of the area of interest in the user image. In another embodiment, the mask of an area of interest may include specific pixels of the area of interest, and the specific pixels may include at least the foreground information. The computing server may be further configured to generate a user document by merging the mask of each area of interest of the user image onto a corresponding area of the template image.

Various document generation methods and systems of the disclosure facilitate an online way for generating a user document (i.e., a digital document) based on a user image of a hand-filled document. The computing server may generate the user document based on at least the user image received from the user-computing device. With such document generation, the computing server may generate precise and clear user document. Further, the requirement of the manpower for generating softcopies of user-filled documents may be reduced. Further, the requirement of a physical space for storing hardcopies of the user-filled documents may be reduced. Thus, the disclosed methods and the systems facilitate an efficient, effective, and comprehensive way of generating the user document by using the user image and the template image corresponding to the user image.

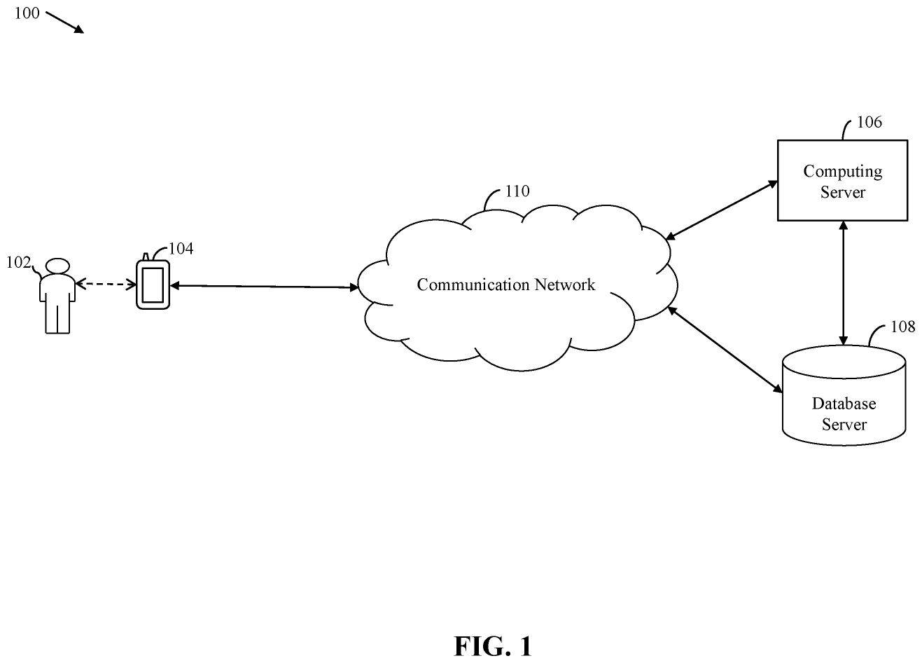

FIG. 1 is a block diagram that illustrates an environment 100 for document generation, in accordance with an exemplary embodiment of the disclosure. The environment 100 includes a user 102, a user-computing device 104, a computing server 106, a database server 108, and a communication network 110. The user-computing device 104, the computing server 106, and the database server 108 may be coupled to each other via the communication network 110.

The user 102 is an individual who may want, or may have been directed, to fill a hardcopy of a template document, for example, a user form such as an application form. In one example, the user 102 may obtain the hardcopy of the template document from another user (not shown). In another example, the user-computing device 104 may be utilized, by the user 102, to download a softcopy of the template document from a web server, and thereafter, printing the softcopy of the template document by utilizing a printer device (not shown) to obtain the hardcopy of template document. Hereinafter, the softcopy of the template document has been referred to as a first template document, and the hardcopy of the template document has been referred to as a second template document. The first or second template document may include one or more titles and one or more relevant sections corresponding to the one or more titles for filling in relevant information. The user 102 may utilize a writing instrument (such as a pen or a pencil) to provide the relevant information in the one or more relevant sections of the second template document.

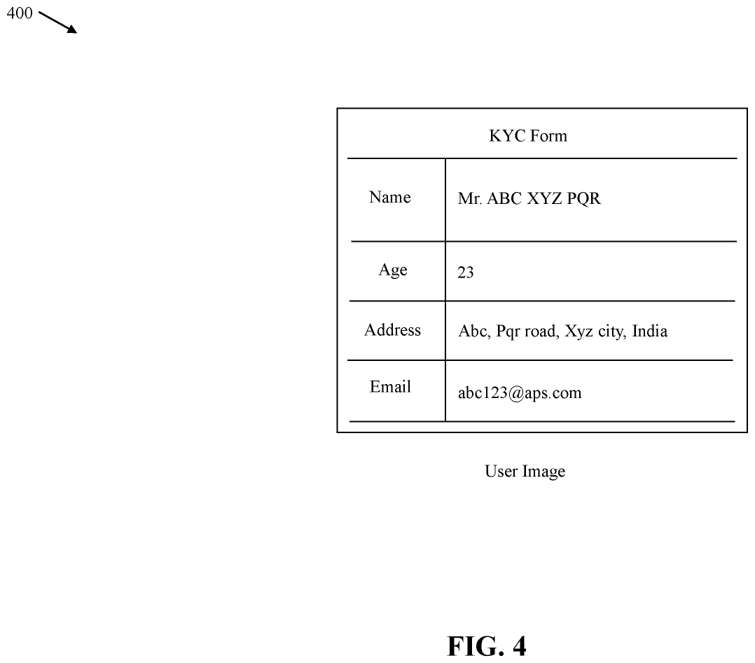

The user-computing device 104 may include suitable logic, circuitry, interfaces, and/or code, executable by the circuitry, that may be configured to perform one or more operations. The one or more operations may include receiving or downloading the first template document from the computing server 106, the database server 108, or a third-party server (not shown) via the communication network 110. In an example, the first template document may be received or downloaded based on browsing activities of the user 102 on a web server hosted by the computing server 106 or the database server 108. After receiving or downloading the first template document, the user-computing device 104 may be utilized, by the user 102, to print the first template document by using a printer device (not shown) coupled to the user-computing device 104 via the communication network 110. The first template document may be printed on a paper to obtain the second template document. After filling the relevant information in the one or more relevant sections of the second template document (i.e., a user-filled document), the user-computing device 104 may be utilized, by the user 102, to capture an image of the user-filled document or scan the user-filled document to obtain a user image as shown in FIG. 4. Upon generating the user image based on a capturing or scanning process, the user-computing device 104 may be configured to transmit the user image to a source server such as the computing server 106 or the database server 108 via the communication network 110. The user-computing device 104 may transmit the user image to the computing server 106 or the database server 108 based on a confirmation input provided by the user 102. The confirmation input may correspond to a touch-based input, a voice-based input, or a gesture-based input provided by the user 102 by using various input modules facilitated by the user-computing device 104. Examples of the user-computing device 104 may include, but are not limited to, a personal computer, a laptop, a smartphone, and a tablet computer.

The computing server 106 may include suitable logic, circuitry, interfaces, and/or code, executable by the circuitry, that may be configured to perform one or more operations for document generation. The computing server 106 may be a computing device, which may include a software framework, that may be configured to create the computing server implementation and perform the various operations associated with the document generation. The computing server 106 may be realized through various web-based technologies, such as, but not limited to, a Java web-framework, a .NET framework, a professional hypertext preprocessor (PHP) framework, a python framework, or any other web-application framework. The computing server 106 may also be realized as a machine-learning model that implements any suitable machine-learning techniques, statistical techniques, or probabilistic techniques. Examples of such techniques may include expert systems, fuzzy logic, support vector machines (SVM), Hidden Markov models (HMMs), greedy search algorithms, rule-based systems, Bayesian models (e.g., Bayesian networks), neural networks, decision tree learning methods, other non-linear training techniques, data fusion, utility-based analytical systems, or the like. Examples of the computing server 106 may include, but are not limited to, a personal computer, a laptop, or a network of computer systems.

In an embodiment, the computing server 106 may be configured to receive the user image (i.e., an image of the user-filled document) from the user-computing device 104 via the communication network 110. The computing server 106 may be configured to extract a first set of key points along with a first set of descriptors from a template image (i.e., an image of the first template document) and a second set of key points along with a second set of descriptors from the user image. A set of key points is a set of pixels corresponding to an element (such a letter, a number, a line, a special character, or the like) in the template image or the user image. A descriptor associated with a key point is indicative of a location of a pixel in the template image or the user image. The descriptor may be characterized by a set of integer values such as 2, 4, 8, 16, 32, or 64 integer values. Thus, if an image (such as the template image or the user image) includes 7339 key points and the descriptor of each key point is characterized by 64 integer values, then the descriptors for the image is a matrix of size 7339*64.

The computing server 106 may be further configured to perform a matching between the first set of key points and the second set of key points. The matching may be performed based on the first set of descriptors of the first set of key points and the second set of descriptors of the second set of key points. Based on the matching, the computing server 106 may be further configured to obtain one-to-one mapping between a first subset of the first set of key points and a second subset of the second set of key points. The computing server 106 may be further configured to determine a transformation based on a comparison between the one-to-one mapping and a threshold value. If the one-to-one mapping between the first subset and the second subset is greater than the threshold value, then the computing server 106 may determine the transformation that maps each pixel coordinate of the template image to a pixel coordinate of the user image. The computing server 106 may be further configured to determine one or more areas of interest in the user image based on the transformation. The computing server 106 may be further configured to execute an inverse transformation of the determined transformation based on the one or more areas of interest. The inverse transformation may include at least correcting orientation, rotation, and perspective of the one or more areas of interest.

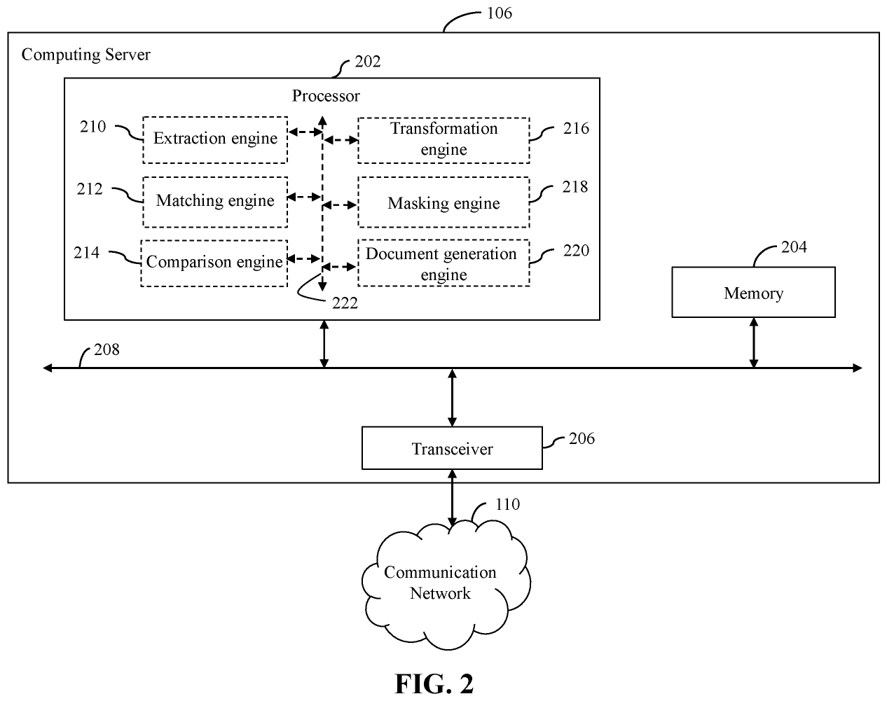

The computing server 106 may be further configured to mask the one or more areas of interest to obtain one or more mask, respectively. Each mask of an area of interest may include at least foreground information associated with the area of interest. The foreground information of each area of interest may include analog content (i.e., handwritten content) incorporated or filled-in by the user 102. The computing server 106 may be further configured to generate the user document by merging the mask of each area of interest of the user image onto a corresponding area of the template image. For example, the user document may be generated by merging the mask including the foreground information onto the corresponding area of the template image. The computing server 106 may be further configured to store the user document in the database server 108. Various operations of the computing server 106 have been described in detail in conjunction with FIGS. 2-6.

The database server 108 may include suitable logic, circuitry, interfaces, and/or code, executable by the circuitry, that may be configured to perform one or more database operations, such as receiving, storing, processing, and transmitting queries, data, documents, images, or content. The database server 108 may be a data management and storage computing device that is communicatively coupled to the user-computing device 104 and the computing server 106 via the communication network 110 to perform the one or more database operations. In an exemplary embodiment, the database server 108 may be configured to manage and store the first template document in various formats such as PDF, Doc, XML, PPT, JPG, and the like. Further, the database server 108 may be configured to manage and store the user image (received from the user-computing device 104) and the template image in various formats such as raster formats (e.g., JPEG, JFIF, JPEG 2000, Exif, TIFF, GIF, BMP, PNG, or the like), vector formats (e.g., CGM, Gerber, SVG, 3D vector, or the like), compound formats (e.g., EPS, PDF, PICT, WMF, SWF, or the like), or stereo formats (e.g., MPO, PNS, JPS, or the like). The database server 108 may be further configured to manage and store one or more user documents generated for one or more users such as the user document of the user 102.

In an embodiment, the database server 108 may be configured to generate a tabular data structure including one or more rows and columns and store the one or more user documents of the one or more users in a structured manner. For example, each row may be associated with a unique user (such as the user 102) having a unique user ID, and the one or more columns corresponding to each row may indicate at least the user document, an address of the user document, a file size of the user document, or any combination thereof.

In an embodiment, the database server 108 may be configured to receive one or more queries from the user-computing device 104 or the computing server 106 via the communication network 110. The one or more queries may indicate one or more requests for retrieving the first template document, the template image, or the user document of the user 102. For example, the database server 108 may receive a query from the user-computing device 104 for retrieving the first template document. In response to the received query, the database server 108 may retrieve and transmit the requested information (i.e., the first template document) to the user-computing device 104 via the communication network 110. In another example, the database server 108 may receive a query from the computing server 106 for retrieving the template image. In response to the received query, the database server 108 may retrieve and transmit the requested information (i.e., the template image) to the computing server 106 via the communication network 110. Examples of the database server 108 may include, but are not limited to, a personal computer, a laptop, or a network of computer systems.

The communication network 110 may include suitable logic, circuitry, interfaces, and/or code, executable by the circuitry, that may be configured to transmit queries, messages, images, documents, and requests between various entities, such as the user-computing device 104, the computing server 106, and/or the database server 108. Examples of the communication network 110 may include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and a combination thereof. Various entities in the environment 100 may be coupled to the communication network 110 in accordance with various wired and wireless communication protocols, such as Transmission Control Protocol and Internet Protocol (TCP/IP), User Datagram Protocol (UDP), Long Term Evolution (LTE) communication protocols, or any combination thereof.

In operation, the user-computing device 104 may be utilized, by the user 102, to download the first template document (i.e., the softcopy of the template document) from a web server via the communication network 110. In one example, the web server may correspond to the computing server 106. In another example, the web server may be hosted by the computing server 106. In another example, the web server may correspond to the third-party server. The first template document may also be retrieved from a storage device such as the database server 108. In an embodiment, the first template document may be downloaded or retrieved in one of the various formats such as the PDF format, the DOC format, the JPG format, or the like. Further, the user-computing device 104 may be utilized, by the user 102, for printing the first template document on a paper to obtain the second template document (i.e., the hardcopy of the template document). The printing device coupled to the user-computing device 104 may be utilized, by the user 102, to obtain the second template document. The first or second template document may include the one or more titles and the one or more relevant sections corresponding to the one or more titles for filling in the relevant information. The user 102 may utilize the writing instrument (such as a pen or a pencil) to fill or insert the relevant information in the one or more relevant sections of the second template document. The relevant information may be manually filled by the user 102 in the second template image i.e., in an analog manner. The filled-in second template document may be referred as the user-filled document.

In an embodiment, the user-computing device 104 may be configured to capture the image of the user-filled document (i.e., the filled-in second template document) and generate the user image of the user-filled document. The user image may be generated based on the confirmation input provided by the user 102. Upon generation of the user image, the user-computing device 104 may be configured to transmit the user image to the computing server 106 or the database server 108 via the communication network 110. In another embodiment, the user-computing device 104 may be utilized, by the user 102, to scan the user-filled document and generate the user image. The user-computing device 104 may transmit the user image to the computing server 106 or the database server 108 via the communication network 110.

In an embodiment, the computing server 106 may be configured to receive the user image from the user-computing device 104. In another embodiment, the computing server 106 may be configured to retrieve the user image from the database server 108. The computing server 106 may be further configured to process the user image to generate the user document for the user 102. For generating the user document, the computing server 106 may be configured to retrieve the template image from the database server 108 based on the user image. Thereafter, the computing server 106 may be configured to extract the first set of key points (such as patterns or informative pixels) along with the first set of descriptors from the template image. The computing server 106 may be further configured to extract the second set of key points (such as patterns or informative pixels) along with the second set of descriptors from the user image. The computing server 106 may be further configured to perform probabilistic matching between the first set of key points and the second set of key points. The probabilistic matching may be performed to obtain the one-to-one mapping between the first subset of the first set of key points and the second subset of the second set of key points.

In an embodiment, the computing server 106 may be further configured to determine the transformation that maps each pixel coordinate of the template image to the pixel coordinate of the user image. The transformation may be determined based on the matching (i.e., the one-to-one mapping) and the threshold value. If the matching (i.e., the one-to-one mapping between the first subset and the second subset) is greater than the threshold value, then the computing server 106 may determine the transformation. The transformation may indicate a mapping of each pixel coordinate of the template image and each pixel coordinate of the user image irrespective of orientation, rotation, and perspective of the template in the user image. In an embodiment, the computing server 106 may be further configured to determine the one or more areas of interest in the user image based on the determined transformation. The one or more areas of interest may be determined by using the mapping of the pixel coordinates of the template image and the pixel coordinates of the user image. In an embodiment, the computing server 106 may be further configured to perform the inverse transformation of the determined transformation based on the one or more areas of interest of the user image. The inverse transformation may be a process of transforming back the one or more areas of interest into an image-space of the template image. The inverse transformation may be performed for correcting orientation, rotation, and perspective of the one or more areas of interest so that the one or more areas of interest directly fit into one or more respective areas of the template image.

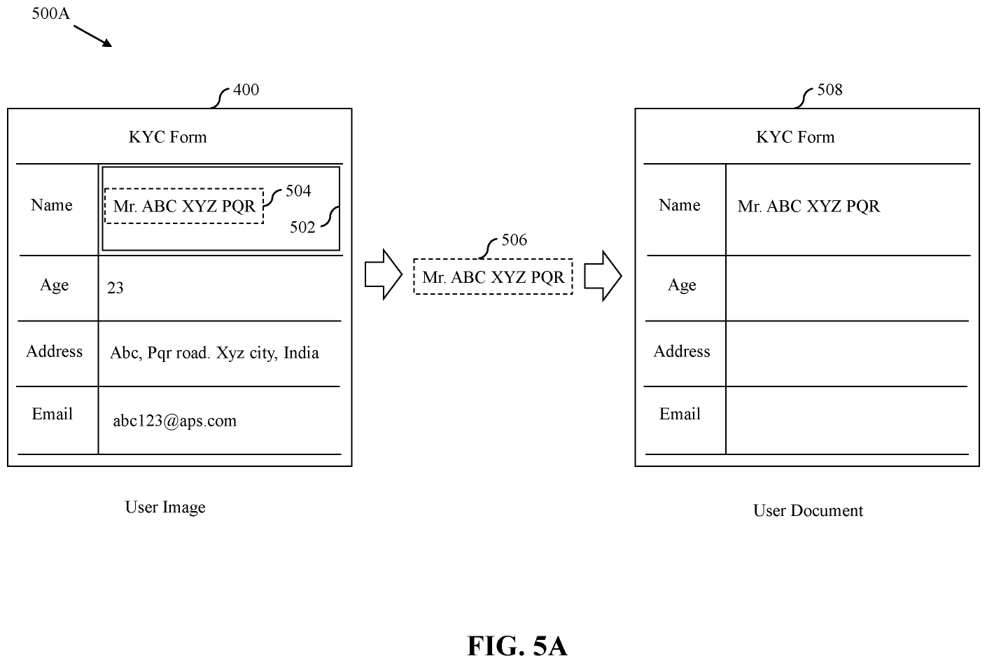

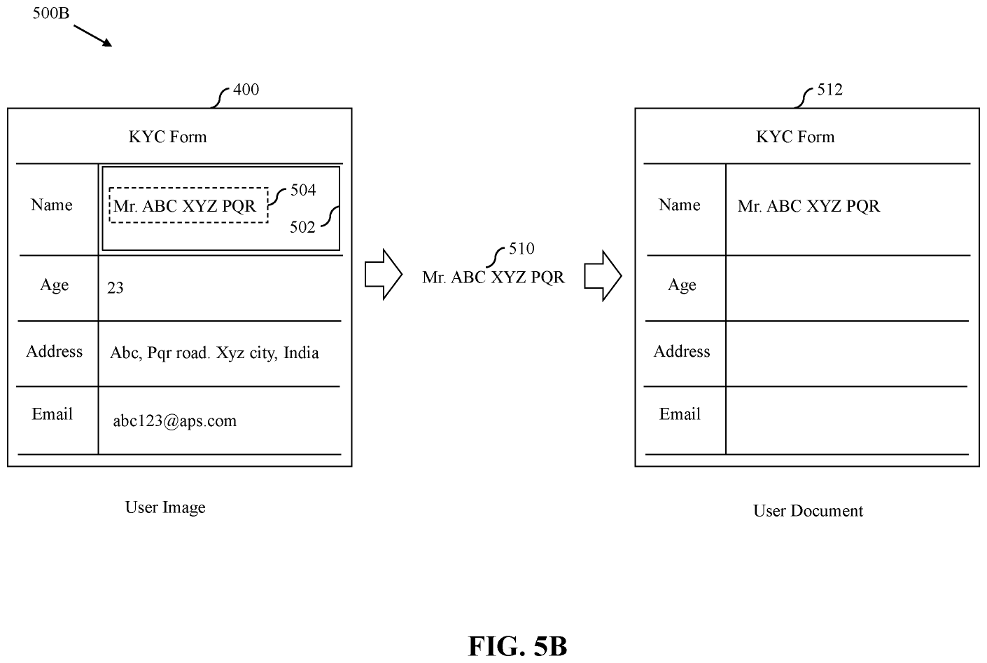

In an embodiment, the computing server 106 may be configured to generate one or more shapes along one or more specific portions (as shown in FIG. 5A) of the one or more areas of interest. A specific portion is a part of the area of interest that may include the foreground information. The computing server 106 may be further configured to obtain the mask (as shown in FIG. 5A) for the specific portion in the user image. The mask may be obtained by executing a masking operation on each area of interest that masks the one or more specific portions or pixels in the area of interest that have been actually changed or updated by the user 102. The mask for each area of interest may be obtained by performing adaptive thresholding for that particular area of interest, and segregating the background information (i.e., static content or untouched area by the user 102) and the foreground information (i.e., the user-filled content) in that particular area of interest. The adaptive thresholding is a form of thresholding (i.e., a form of image segmentation) that takes into account spatial variations in illumination associated with each area of interest. The adaptive thresholding may be executed by using a binary thresholding, an Otsu thresholding, or a combination thereof. The adaptive thresholding may also be executed by using other thresholding methods that are known in the art.

Based on the masking, the mask of the area of interest may be obtained. The mask of the area of interest may include the one or more specific portions of the area of interest. Each specific portion may include at least the foreground information, and the combined shape and size of each specific portion is less than an actual shape and size of the area of interest. In an embodiment, the computing server 106 may be further configured to generate one or more contours along the specific portion of the area of interest. The one or more contours may be generated based on at least the foreground information of the area of interest to obtain the one or more specific portions of the area of interest in the user image. Thus, based on the masking of the one or more areas of interest, the computing server 106 may extract two main layers from each area of interest. One layer corresponds to what was already there in the template image and the other layer corresponds to what the user 102 may have filled the user image.

Further, in an embodiment, to generate the user document for the user 102, the computing server 106 may be configured to merge the mask of each area of interest onto the corresponding area of the template image. For example, the mask including the foreground information may be placed in the corresponding area of the template image to generate the user document. The generated user document may be similar to the template image but include the relevant information filled by the user 102. In some embodiments, the digital document may include the digited version of the relevant information. For example, if the area of interest includes the foreground information that may be digitized, then the computing server 106 may perform an optical character recognition (OCR) operation on the area of interest to digitize the foreground information included in the area of interest by the user 102. In such a scenario, instead of placing the foreground information (i.e., the user filled content) in its original form, the computing server 106 may place the digitized version of the relevant information onto the corresponding area of the template image to generate the user document for the user 102. Upon generation of the user document, the computing server 106 may store the user document in the database server 108. Various operations along with their advantages and improvements of the disclosure will become apparent in conjunction with FIGS. 2-4, 5A-5B, and 6.

FIG. 2 is a block diagram that illustrates the computing server 106, in accordance with an exemplary embodiment of the disclosure. The computing server 106 includes the circuitry such as a processor 202, a memory 204, and a transceiver 206 that communicate with each other via a communication bus 208. The processor 202 may include circuitry such an extraction engine 210, a matching engine 212, a comparison engine 214, a transformation engine 216, a masking engine 218, and a document generation engine 220 that communicate with each other via a communication bus 222.

The processor 202 may include suitable logic, circuitry, interfaces, and/or code, executable by the circuitry, that may be configured to perform the one or more operations for generating the one or more user documents for the one or more users such as the user document generated for the user 102. Examples of the processor 202 may include, but are not limited to, an application-specific integrated circuit (ASIC) processor, a reduced instruction set computing (RISC) processor, a complex instruction set computing (CISC) processor, and a field-programmable gate array (FPGA). It will be apparent to a person skilled in the art that the processor 202 may be compatible with multiple operating systems.

In an embodiment, the processor 202 may be configured to receive the user image from the user-computing device 104 via the communication network 110. The processor 202 may be configured to control and manage the extraction of the first set of key points along with the first set of descriptors and the second set of key points along with the second set of descriptors by using the extraction engine 210. The processor 202 may be further configured to control and manage the probabilistic matching of the first set of key points and the second set of key points by using the matching engine 212. The processor 202 may be further configured to control and manage the transformation that maps each pixel coordinate of the template image to the pixel coordinate of the user image by using the comparison engine 214. The processor 202 may be further configured to control and manage the inverse transformation on each area of interest of the user image by using the transformation engine 216. The processor 202 may be further configured to control and manage the masking of the one or more specific portions of each area of interest by using the masking engine 218. The processor 202 may be further configured to control and manage the generation of the user document by merging the mask of the foreground information of each area of interest of the user image onto the corresponding area of the template image by using the document generation engine 220.

In an embodiment, the processor 202 may be configured to operate as a master processing unit, and the extraction engine 210, the matching engine 212, the comparison engine 214, the transformation engine 216, the masking engine 218, and the document generation engine 220 may be configured to operate as slave processing units. In such a scenario, the processor 202 may instruct the extraction engine 210, the matching engine 212, the comparison engine 214, the transformation engine 216, the masking engine 218, and the document generation engine 220 to perform their corresponding operations either independently or in conjunction with each other.

The memory 204 may include suitable logic, circuitry, interfaces, and/or code, executable by the circuitry, that may be configured to store one or more instructions or code that are executed by the processor 202, the transceiver 206, the extraction engine 210, the matching engine 212, the comparison engine 214, the transformation engine 216, the masking engine 218, and the document generation engine 220 to perform the one or more associated operations. In an exemplary embodiment, the memory 204 may be further configured to store the template image and the user image. Further, the memory 204 may be further configured to store the first set of key points and the second set of key points along with the first set of descriptors and the second set of descriptors. The memory 204 may be further configured to store the foreground information masked by the masking engine 218. The memory 204 may be further configured to store the user document generated by the document generation engine 220. Examples of the memory 204 may include, but are not limited to, a random-access memory (RAM), a read-only memory (ROM), a programmable ROM (PROM), and an erasable PROM (EPROM).

The transceiver 206 may include suitable logic, circuitry, interfaces, and/or code, executable by the circuitry, that may be configured to transmit (or receive) data to (or from) various servers or devices, such as the user-computing device 104 or the database server 108. Examples of the transceiver 206 may include, but are not limited to, an antenna, a radio frequency transceiver, a wireless transceiver, and a Bluetooth transceiver. The transceiver 206 may be configured to communicate with the user-computing device 104 or the database server 108 using various wired and wireless communication protocols, such as TCP/IP, UDP, LTE communication protocols, or any combination thereof.

The extraction engine 210 may include suitable logic, circuitry, interfaces, and/or code, executable by the circuitry, that may be configured to execute one or more extraction operations. For example, the extraction engine 210 may be configured to extract the first set of key points along with the first set of descriptors from the template image and the second set of key points along with the second set of descriptors from the user image. The extraction engine 210 may be further configured to store the first set of key points and the second set of key points along with the first set of descriptors and the second set of descriptors in the memory 204. The extraction engine 210 may be implemented by one or more processors, such as, but are not limited to, an ASIC processor, a RISC processor, a CISC processor, and an FPGA.

The matching engine 212 may include suitable logic, circuitry, interfaces, and/or code, executable by the circuitry, that may be configured to execute one or more matching operations. For example, the matching engine 208 may be configured to perform the matching between the first set of key points and the second set of key points based on the first set of descriptors and the second set of descriptors. The matching engine 208 may be configured to obtain the one-to-one mapping between a first subset of key points and a second subset of key points. The first subset of key points may correspond to the first subset of the first set of key points and the second subset of key points may correspond to the second subset of the second set of key points. The matching engine 212 may be further configured to store the one-to-one mapping in the memory 204. The matching engine 212 may be implemented by one or more processors, such as, but are not limited to, an ASIC processor, a RISC processor, a CISC processor, and an FPGA.

The comparison engine 214 may include suitable logic, circuitry, interfaces, and/or code, executable by the circuitry, that may be configured to perform one or more comparison operations. For example, the comparison engine 214 may be configured to compare the one-to-one mapping with the threshold value. The comparison engine 214 may be implemented by one or more processors, such as, but are not limited to, an ASIC processor, a RISC processor, a CISC processor, and an FPGA.

The transformation engine 216 may include suitable logic, circuitry, interfaces, and/or code, executable by the circuitry, that may be configured to determine the transformation and execute one or more inverse transformation operations. For example, the transformation engine 216 may be configured to determine the transformation in the user image based on the comparison between the one-to-one mapping and the threshold value. The transformation may be indicative of one or more locations of the one or more areas of interest in the user image. The transformation engine 216 may be further configured to perform the inverse transformation of the transformation to transform back the one or more areas of interest into the image-space of the template image. The transformation engine 216 may be further configured to correct orientation, rotation, and perspective of the one or more areas of interest. The transformation engine 216 may be implemented by one or more processors, such as, but are not limited to, an ASIC processor, a RISC processor, a CISC processor, and an FPGA.

The masking engine 218 may include suitable logic, circuitry, interfaces, and/or code, executable by the circuitry, that may be configured to execute one or more masking operations. For example, the masking engine 218 may be configured to mask the one or more areas of interest. Each mask may include the one or more specific portions of an area of interest. Each specific portion may include the foreground information associated with the area of interest. In one embodiment, the mask may be generated for the one or more shapes formed along the foreground information present in the one or more specific portions. In another embodiment, the mask may be generated for the one or more specific pixels that represents the foreground information in the one or more specific portions. In another embodiment, the masking engine 218 may be configured to generate the one or more contours along the foreground information present in the one or more specific portions. The masking engine 218 may be further configured to generate the mask for the foreground information present in the one or more contours. The masking engine 218 may be implemented by one or more processors, such as, but are not limited to, an ASIC processor, a RISC processor, a CISC processor, and an FPGA.

The document generation engine 220 may include suitable logic, circuitry, interfaces, and/or code, executable by the circuitry, that may be configured to execute one or more document generation operations. For example, the document generation engine 220 may be configured to generate the user document by merging the mask including at least the foreground information onto the corresponding area of the template image. The document generation engine 220 may be implemented by one or more processors, such as, but are not limited to, an ASIC processor, a RISC processor, a CISC processor, and an FPGA.

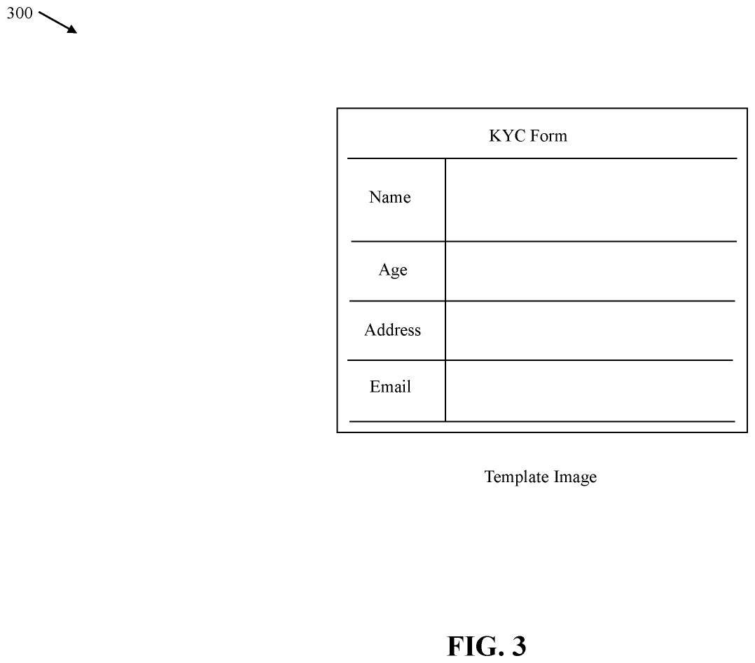

FIG. 3 is a diagram that illustrates a template image 300 of the first template document, in accordance with an exemplary embodiment of the disclosure. In one example, the template image 300 may be an image of the first template document. In another example, the template image 300 may be a scanned copy of the first template document. In another example, the template image 300 may be the first template document in its original form. In an exemplary embodiment, the template image 300 may correspond to a know your customer (KYC) form as shown in FIG. 3. The KYC form may include one or more fields that are representative of one or more attributes associated with a customer such as the user 102. The one or more attributes may correspond to, but are not limited to, a name, an age, an address, and an email. Further, the one or more attributes may be presented along one or more rows and/or columns.

FIG. 4 is a diagram that illustrates a user image 400 of the second template document hand-filled by the user 102, in accordance with an exemplary embodiment of the disclosure. The second template document may be hand-filled by the user 102 using the writing instrument such as a pen. For example, a hardcopy of the KYC form (obtained by the user 102) may be filled by the user 102 by incorporating or writing down the relevant information corresponding to each attribute. After filling in the relevant information in the KYC form, the user-computing device 104 may be utilized, by the user 102, to generate the user image 400 by capturing an image of the filled-in KYC form. The user image 400 may include the one or more fields representing the one or more attributes such as the name, the age, the address, and the email along with the relevant information corresponding to each attribute provided by the user 102 in a respective available field. For example, the relevant information may include the name of the user 102 (such as Mr. ABC XYZ PQR), the age of the user 102 (such as 23), the address of the user 102 (such as Abc, Pqr road, Xyz city, India), and the email of the user 102 (such as abc123@aps.com) as shown in FIG. 4.

FIG. 5A is a diagram 500A that illustrates an exemplary scenario for document generation, in accordance with an exemplary embodiment of the disclosure. The exemplary scenario shows the user image 400, an area of interest 502, a specific portion 504, a mask 506, and a user document 508. The user image 400 includes the area of interest 502, the specific portion 504, and the mask 506 for the specific portion 504 of the area of interest 502. The template image 300 may be downloaded by the user 102. The relevant information may be filled by the user 102 in the one or more corresponding areas of the template image 300. The user-computing device 104 may capture the user image 400 of the user-filled document. The user-computing device 104 may further transmit the user image 400 to the computing server 106 via the communication network 110.

The computing server 106 may receive the user image 400 from the user-computing device 104 via the communication network 110. The computing server 106 may extract the second set of key points (i.e., a second set of pixels or pixel coordinates) along with the second set of descriptors (i.e., a second set of locations of each pixel or pixel coordinates) from the user image 400. The computing server 106 may retrieve the template image 300 from the database server 108. The computing server 106 may further extract the first set of key points (i.e., a first set of pixels or pixel coordinates) along with the first set of descriptors (i.e., a first set of locations of each pixel or pixel value) from the template image 300. The second set of pixels or pixel coordinates include at least the first set of pixels or pixel coordinates. In addition to the first set of pixels or pixel coordinates, the second set of pixel or pixel coordinates may also include pixels or pixel coordinates corresponding to the relevant information filled-in by the user 102. Thus, a count of locations in the second set of locations is greater than a count of locations in the first set of locations.

The computing server 106 may perform the one-to-one mapping between the first subset of key points and the second subset of key points. The computing server 106 may further determine the transformation when the one-to-one mapping is greater than the threshold value. The computing server 106 may further determine the one or more areas of interest (such as the area of interest 502) in the user image 400 based on the transformation. The computing server 106 may further perform the inverse transformation on the area of interest 502, and obtain the foreground information associated with the area of interest 502. The computing server 106 may further generate the mask 506 for the specific portion 504. To generate the user document 508, the computing server 106 may place or merge the mask 506 onto a corresponding area of the template image 300, as shown in FIG. 5A.

FIG. 5B is a diagram 500B that illustrates an exemplary scenario for document generation, in accordance with another exemplary embodiment of the disclosure. The exemplary scenario shows the user image 400, the area of interest 502, the specific portion 504, a mask 510, and a user document 512. In this exemplary embodiment, the computing server 106 may generate the mask 510 based on the one or more specific pixels (or the one or more contours around the one or more specific pixels) in the specific portion 504 of the user image 400. The one or more pixels may correspond to the relevant information filled by the user 102. The one or more pixels may be identified based on a change in pixel values across one or more pixels rows and columns associated with the specific portion 504. Further, to generate the user document 512, the computing server 106 may place or merge the mask 510 onto a corresponding area of the template image 300, as shown in FIG. 5B.

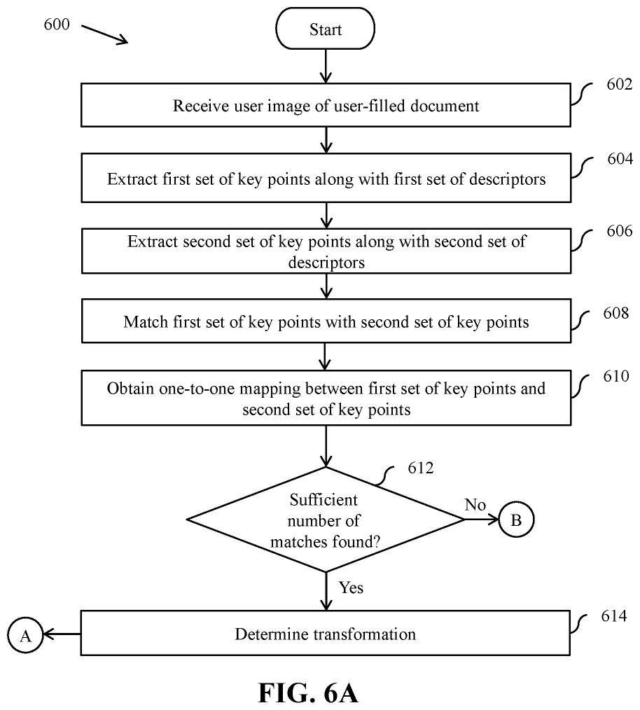

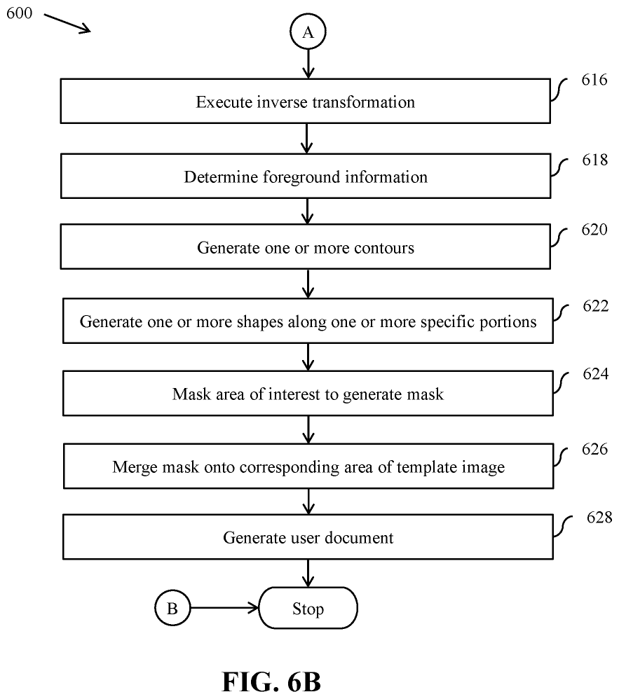

FIGS. 6A-6B, collectively, illustrate a flow chart 600 of a method for generating a digital document (such as the user document 508 or 512), in accordance with an exemplary embodiment of the disclosure.

At 602, the user image 400 of the user-filled document (i.e., the second template document manually hand-filled by the user 102 using the measuring instrument such as a pen) is received. The computing server 106 may be configured to receive the user image 400 from the user-computing device 104 via the communication network 110.

At 604, the first set of key points (such as the first set of pixels) along with the first set of descriptors (such as the first set of locations) is extracted. The computing server 106 may be configured to extract the first set of key points along with the first set of descriptors from the template image 300.

At 606, the second set of key points (such as the second set of pixels) along with the second set of descriptors (such as the second set of locations) is extracted. The computing server 106 may be configured to extract the second set of key points along with the second set of descriptors from the user image 400.

At 608, the first set of key points is matched with the second set of key points. The computing server 106 may be configured to match the first set of key points with the second set of key points based on the first set of descriptors and the second set of descriptors.

At 610, the one-to-one mapping between the first set of key points and the second set of key points is obtained. The computing server 106 may be configured to obtain the one-to-one mapping based on the matching.

At 612, it is determined whether a sufficient number of matches has been found or not. The computing server 106 may be configured to determine whether the sufficient number of matches has been found or not based on the matching. If at 612, it is determined that the matching is greater than the threshold value, then 614 is performed. If at 612, it is determined that the matching is less than the threshold value, then the process ends.

At 614, the transformation is determined. The computing server 106 may be configured to determine the transformation that maps each pixel coordinate of the template image 300 to the pixel coordinate of the user image 400 when the matching between the first set of key points and the second set of key points is greater than the threshold value. The transformation may be indicative of the one or more locations of the one or more areas of interest (or pixels in the one or more areas of interest) in the user image 400.

At 616, the inverse transformation is executed. The computing server 106 may be configured to execute the inverse transformation of the determined transformation based on the one or more areas of interest. The inverse transformation may be executed by transforming back the one or more areas of interest into an image-space of the template image 300.

At 618, the foreground information is determined. The computing server 106 may be configured to determine the foreground information. The foreground information may be determined based on the one or more specific portions 504 of the one or more areas of interest of the user image 400. At 620, the one or more contours are generated. The computing server 106 may be configured to generate the one or more contours. The computing server 106 may generate the one or more contours based on at least the foreground information of the area of interest to obtain the one or more specific portions 504 of the area of interest in the user image 400.

At 622, the one or more shapes along the one or more specific portions 504 are generated. The computing server 106 may be configured to generate the one or more shapes along the one or more specific portions 504. The computing server 106 may generate the one or more shapes based on at least the one or more locations of the one or more pixels in the one or more specific portions 504.

At 624, the area of interest 502 is masked to generate the mask 506. The computing server 106 may be configured to generate the mask 506 of the area of interest 502 of the user image 400. In one exemplary embodiment, the mask 506 may be generated based on the one or more shapes associated with the one or more specific portions 504. In another exemplary embodiment, the mask 510 may be generated based on the one or more specific pixels associated with the one or more specific portions 504. Each specific portion may include the foreground information. In an embodiment, a combined shape and size of the one or more specific portions 504 may be less than the actual shape and size of the area of interest 502.

At 626, the mask 506 is merged onto the corresponding area of the template image 300. The computing server 106 may be configured to merge the mask 506 or 510 onto the corresponding areas of the template image 300. At 628, the user document 508 or 512 is generated. The computing server 106 may be configured to generate the user document 508 or 512 based on the merging.

In another embodiment, the user-computing device 104 may be configured to capture the user image 400 of the user-filled document. The user-computing device 104 may be further configured to transmit the user image 400 to the computing server 106. The computing server 106 may be configured to extract the first set key points and the second set of key points from the template image 300 and the user image 400, respectively. The computing server 106 may be further configured to perform probabilistic matching between the first set of key points and the second set of key points. The computing server 106 may be further configured to generate the mask 510 for the one or more specific pixels in the specific portion 504 of the user image 400. The computing server 106 may be further configured to generate the user document 512 by merging the mask 510 of the one or more specific pixels with the template image 300.

In another embodiment, the user-computing device 104 may be configured to capture the user image 400 of the user-filled document. The user-computing device 104 may be further configured to transmit the user image 400 to the computing server 106. The computing server 106 may be configured to extract the first set key points and the second set of key points from the template image 300 and the user image 400, respectively. The computing server 106 may be further configured to perform probabilistic matching between the first set of key points and the second set of key points. The computing server 106 may be configured to generate the contour along the specific portion 504 of the user image 400. The computing server 106 may be further configured to generate the mask 506 for the contour generated along the specific portion 504 of the user image 400. The computing server 106 may be further configured to generate the user document 508 by merging the mask 506 of the contour with the template image 300.

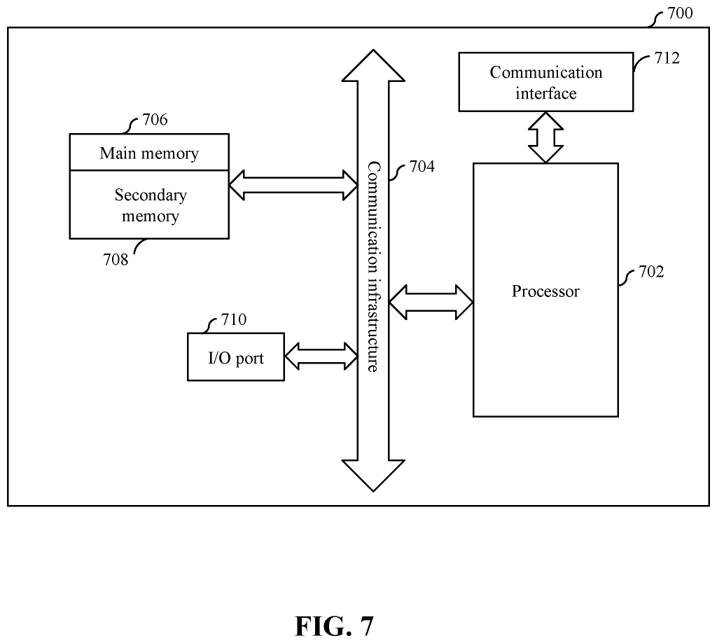

FIG. 7 is a block diagram that illustrates a system architecture of a computer system 700 for generating a digital document (such as the user document 508 or 512), in accordance with an exemplary embodiment of the disclosure. An embodiment of the disclosure, or portions thereof, may be implemented as computer readable code on the computer system 700. In one example, the computing server 106 and the database server 108 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the document generation methods of FIGS. 6A and 6B.

The computer system 700 may include a processor 702 that may be a special purpose or a general-purpose processing device. The processor 702 may be a single processor, multiple processors, or combinations thereof. The processor 702 may have one or more processor “cores.” Further, the processor 702 may be coupled to a communication infrastructure 704, such as a bus, a bridge, a message queue, multi-core message-passing scheme, the communication network 110, or the like. The computer system 700 may further include a main memory 706 and a secondary memory 708. Examples of the main memory 706 may include RAM, ROM, and the like. The secondary memory 708 may include a hard disk drive or a removable storage drive (not shown), such as a floppy disk drive, a magnetic tape drive, a compact disc, an optical disk drive, a flash memory, or the like. Further, the removable storage drive may read from and/or write to a removable storage device in a manner known in the art. In an embodiment, the removable storage unit may be a non-transitory computer readable recording media.

The computer system 700 may further include an input/output (I/O) port 710 and a communication interface 712. The I/O port 710 may include various input and output devices that are configured to communicate with the processor 702. Examples of the input devices may include a keyboard, a mouse, a joystick, a touchscreen, a microphone, and the like. Examples of the output devices may include a display screen, a speaker, headphones, and the like. The communication interface 712 may be configured to allow data to be transferred between the computer system 700 and various devices that are communicatively coupled to the computer system 700. Examples of the communication interface 712 may include a modem, a network interface, i.e., an Ethernet card, a communication port, and the like. Data transferred via the communication interface 712 may be signals, such as electronic, electromagnetic, optical, or other signals as will be apparent to a person skilled in the art. The signals may travel via a communications channel, such as the communication network 110, which may be configured to transmit the signals to the various devices that are communicatively coupled to the computer system 700. Examples of the communication channel may include a wired, wireless, and/or optical medium such as cable, fiber optics, a phone line, a cellular phone link, a radio frequency link, and the like. The main memory 706 and the secondary memory 708 may refer to non-transitory computer readable mediums that may provide data that enables the computer system 700 to implement the document generation methods illustrated in FIGS. 6A-6B.

Various embodiments of the disclosure provide the computing server 106 for performing the document generation based on the user image 400. The computing server 106 may receive, from the user-computing device 104, the user image 400 of the user-filled document. The user image 400 may be received when the user-computing device 104 captures the user image 400 of the user-filled document to generate the user document 508. The user image 400 may include at least a name of the user 102, an age of the user 102, an address of the user 102, and an email of the user 102. The computing server 106 may further process the user image 400 to extract the second set of key points. The computing server 106 may further process the template image 300 to extract the first set of key points. The computing server 106 may further perform probabilistic matching of the first set of key points and the second set of key points to determine the transformation in the user image 400. The computing server 106 may further generate the one or more shapes along the one or more specific portions 504 in the user image 400. The computing server 106 may further generate the mask 506 for the one or more shapes. In one embodiment, the computing server 106 may generate the contour along the one or more specific portions 504 of the user image 400. The computing server 106 may further generate the mask 506 for the contour. The computing server 106 may further generate the user document 508 by merging the mask 506 onto the corresponding areas of the template image 300.

Various embodiments of the disclosure provide a non-transitory computer readable medium having stored thereon, computer executable instructions, which when executed by a computer, cause the computer to execute operations for performing the document generation based on the user image 400. The operations include receiving, by the computing server 106 from the user-computing device 104, the user image 400. The user image 400 may be received when the user-computing device 104 captures the user image 400 of the user-filled document to generate the user document. The user image 400 may include at least a name of the user 102, an age of the user 102, an address of the user 102, and an email of the user 102. The operations further include extracting, by the computing server 106, the first set of key points from the template image 300, and the second set of key points from the user image 400. The operations further include determining, by the computing server 106, the transformation that maps each pixel coordinate of the template image 300 to the pixel coordinate of the user image 400 when the matching between the first set of key points and the second set of key points is greater than the threshold value. The transformation may be indicative of the one or more locations of the one or more areas of interest in the user image 400. The operations further include masking, by the computing server 106, each area of interest to obtain the mask including at least the foreground information of each area of interest. The operations further include generating, by the computing server 106, the user document 508 or 512 by merging the mask of each area of interest of the user image 400 onto the corresponding area of the template image 300.

The disclosed embodiments encompass numerous advantages. The disclosure provides various document generation methods and systems for generating the user document based on the user image 400. The computing server 106 may generate the user document 508 or 512 based on the user image 400 received from the user-computing device 104. With such document generation systems and methods, the computing server 106 may generate the precise and clear user document. With the implementation of the document generation methods and systems of the disclosure, the requirement of the manpower for creating softcopies of thousands of user-filled documents is reduced. Further, the large physical space for storing the hardcopies of the thousands of user-filled documents is reduced. Further, only relevant information may be retrieved from the user image 400 as preferred by an entity, and stored in a digital format.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Techniques consistent with the disclosure provide, among other features, systems and methods for document generation. While various exemplary embodiments of the disclosed document generation systems and methods have been described above, it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

What is claimed is:

1. A document generation method, comprising:
receiving, by a computing server, a user image of a user-filled document from a user-computing device via a communication network;
extracting, by the computing server, a first set of key points from a template image, and a second set of key points from the user image;
determining, by the computing server, a transformation that maps each pixel coordinate of the template image to a pixel coordinate of the user image when a matching between the first set of key points and the second set of key points is greater than a threshold value, wherein the transformation is indicative of one or more locations of one or more areas of interest in the user image;
masking, by the computing server, each area of interest to generate a mask including at least foreground information of each area of interest; and
generating, by the computing server, a user document by merging the mask of each area of interest of the user image onto a corresponding area of the template image.

2. The document generation method of claim 1, wherein the user image is generated based on capturing of the user-filled document by the user-computing device, wherein the user-filled document is an updated copy of the template image, and wherein the template image is updated by a user by incorporating analog content in one or more areas of the template image.

3. The document generation method of claim 1, further comprising extracting, by the computing server, a first set of descriptors of the first set of key points from the template image, and a second set of descriptors of the second set of key points from the user image,
wherein the first set of key points and the second set of key points are associated with one or more pixels in the template image and the user image, respectively, and
wherein each descriptor in the first set of descriptors and the second set of descriptors corresponds to a location of a pixel in the template image and the user image, respectively.

4. The document generation method of claim 3, wherein the matching of the first set of key points and the second set of key points is executed based on the first set of descriptors and the second set of descriptors, and wherein the matching is executed to obtain one-to-one mapping between a first subset of the first set of key points and a second subset of the second set of key points.

5. The document generation method of claim 1, further comprising executing, by the computing server, an inverse transformation of the determined transformation based on the one or more areas of interest.

6. The document generation method of claim 5, wherein the inverse transformation is executed by transforming back the one or more areas of interest into an image-space of the template image.

7. The document generation method of claim 6, wherein the inverse transformation includes at least correcting orientation, rotation, and perspective of the one or more areas of interest.

8. The document generation method of claim 1, wherein the mask of an area of interest includes one or more specific portions of the area of interest, wherein the one or more specific portions include at least the foreground information, and wherein a combined shape and size of the one or more specific portions is less than an actual shape and size of the area of interest.

9. The document generation method of claim 8, further comprising generating, by the computing server, one or more contours based on at least the foreground information of the area of interest to obtain the one or more specific portions of the area of interest in the user image.

10. The document generation method of claim 1, wherein the mask of an area of interest includes one or more specific pixels of the area of interest, and wherein the one or more specific pixels include at least the foreground information.

11. The document generation method of claim 1, wherein the foreground information of each area of interest includes analog content incorporated by a user.

12. A document generation system, comprising:
a computing server comprising circuitry configured to:
receive a user image of a user-filled document from a user-computing device via a communication network;
extract a first set of key points from a template image, and a second set of key points from the user image;
determine a transformation that maps each pixel coordinate of the template image to a pixel coordinate of the user image when a match between the first set of key points and the second set of key points is greater than a threshold value, wherein the transformation is indicative of one or more locations of one or more areas of interest in the user image;
mask each area of interest to generate a mask including at least foreground information of each area of interest; and
generate a user document by a merge of the mask of each area of interest of the user image onto a corresponding area of the template image.

13. The document generation system of claim 12, wherein the user image is generated based on capture of the user-filled document by the user-computing device, wherein the user-filled document is an updated copy of the template image, and wherein the template image is updated by a user by incorporating analog content in one or more areas of the template image.

14. The document generation system of claim 12, wherein the circuitry is further configured to extract a first set of descriptors of the first set of key points from the template image, and a second set of descriptors of the second set of key points from the user image,
wherein the first set of key points and the second set of key points are associated with one or more pixels in the template image and the user image, respectively, and
wherein each descriptor in the first set of descriptors and the second set of descriptors corresponds to a location of a pixel in the template image and the user image, respectively.

15. The document generation system of claim 14, wherein the circuitry is further configured to execute the match of the first set of key points and the second set of key points based on the first set of descriptors and the second set of descriptors, and wherein the match is executed to obtain one-to-one mapping between a first subset of the first set of key points and a second subset of the second set of key points.

16. The document generation system of claim 12, wherein the circuitry is further configured to execute an inverse transformation of the determined transformation based on the one or more areas of interest.

17. The document generation system of claim 16, wherein the inverse transformation is executed by transformation back the one or more areas of interest into an image-space of the template image, and wherein the inverse transformation includes at least correction of orientation, rotation, and perspective of the one or more areas of interest.

18. The document generation system of claim 12, wherein the mask of an area of interest includes one or more specific portions of the area of interest, wherein the one or more specific portions include at least the foreground information, and wherein a combined shape and size of the one or more specific portions is less than an actual shape and size of the area of interest.

19. The document generation system of claim 12, wherein the mask of an area of interest includes one or more specific pixels of the area of interest, and wherein the one or more specific pixels include at least the foreground information.

20. The document generation system of claim 12, wherein the foreground information of each area of interest includes analog content incorporated by a user.
